(19) United States
(12) Patent Application Publication
(10) Pub. No.: US 2017/0330059 A1
(43) Pub. Date: Nov. 16, 2017

(54) JOINT OBJECT AND OBJECT PART DETECTION USING WEB SUPERVISION

(71) Applicant: Xerox Corporation, Norwalk, CT (US)

(72) Inventors: David Novotny, Oxford (GB); Diane Larlus Larrondo, La Tronche (FR); Andrea Vedaldi, Oxford (GB)

(73) Assignee: Xerox Corporation, Norwalk, CT (US)

(21) Appl. No.: 15/151,856

(22) Filed: May 11, 2016

(51) Int. Cl. G06K 9/66; G06K 9/46; G06K 9/62

(52) U.S. Cl. CPC G06K 9/66; G06K 9/6267; G06K 9/4604; G06K 9/6202

(57) ABSTRACT

A method for generating object and part detectors includes accessing a collection of training images. The collection of training images includes images annotated with an object label and images annotated with a respective part label for each of a plurality of parts of the object. Joint appearance-geometric embeddings for regions of a set of the training images are generated. At least one detector for the object and its parts is learnt using annotations of the training images and respective joint appearance-geometric embeddings, e.g., using multi-instance learning for generating parameters of scoring functions which are used to identify high scoring regions for learning the object and its parts. The detectors may be output or used to label regions of a new image with object and part labels.

### BACKGROUND

The exemplary embodiment relates to object detection and finds particular application in connection with detection of both an object and its parts in an image.

Object detection is a basic problem in image understanding and an active topic of research in computer vision. Given an image and a predefined set of objects or categories, the goal is to output all regions that contain instances of the considered object or category. Object detection is often a challenging task, due to the variety of imaging conditions (viewpoints, environments, lighting conditions, etc.).

While there has been extensive study of object detection, there has been little investigation of the structure associated with these objects. In particular, there is almost no understanding of their internal composition and geometry. In many practical applications, however, it would be useful to have a finer understanding of the object structure, i.e., of its semantic parts and of the associated geometry. As an example, in facial recognition, it would be helpful to locate parts of the face as well as a bounding box for the face as a whole. Similarly, in vehicle recognition, the identification of parts such as wheels, headlights, and the like, in addition to the vehicle itself, would be useful.

Conventional object detection methods employ annotated images to train a detection model. However, as the complexity of visual models increases and data-consuming technology is adopted, such as deep learning, being able to work with less supervision is advantageous. Object localization methods have been developed for localizing objects in images using less supervision, referred to as weakly supervised object localization (WSOL). See, for example, Minh Hoai Nguyen, et al., “Weakly supervised discriminative localization and classification: a joint learning process,” ICCV, 2009; Megha Pandey, et al., “Scene recognition and weakly supervised object localization with deformable part-based models,” ICCV, 2011; Thomas Deselaers, et al., “Weakly supervised localization and learning with generic knowledge,” ICCV, 2012; C. Wang, et al, “Weakly supervised object localization with latent category learning,” ECCV, pp. 431-445, 2014; Judy Hoffman, et al., “LSDA: Large scale detection through adaptation,” NIPS, 2014; Judy Hoffman, et al., “Detector discovery in the wild: Joint multiple instance and representation learning,” CVPR, 2015; Ramazan Gokberk Cinbis, et al., “Weakly Supervised Object Localization with Multi-fold Multiple Instance Learning,” PAMI, September 2015. These methods assume that for each training image, a list is provided of every object type that it contains. WSOL methods include co-detection methods, which predict bounding boxes, and co-segmentation methods, which predict pixel-level masks. Co-detection methods are described, for example, in A. Joulin, et al., “Efficient image and video co-localization with Frank-Wolfe algorithm,” ECCV, 2014; K. Tang, et al., “Co-localization in real-world images,” CVPR, pp. 1464-147, 2014; Karim Ali, et al., “Confidence-rated multiple instance boosting for object detection,” CVPR, pp. 2433-2400, 2014; and Zhiyuan Shi, et al., “Bayesian joint modelling for object localisation in weakly labelled images,” PAMI, 37(10):1959-1972, October 2015. Co-segmentation methods are described in A. Joulin, et al., “Efficient optimization for discriminative latent class models,” NIPS, 2010; Sara Vicente, et al., “Object cosegmentation,” CVPR, pp. 2217-2224, 2011; Michael Rubinstein, et al., “Unsupervised joint object discovery and segmentation in internet images,” CVPR, pp. 1939-1946, 2013; and A. Joulin, et al., “Multi-class cosegmentation,” CVPR, 2012.

The learning algorithm for WSOL and co-detection methods is given a set of images that all contain at least one instance of a particular object and use multiple instance learning (MIL). See, Nguyen, 2009; Pandey, 2011; Hyun Oh Song, et al., “On learning to localize objects with minimal supervision,” ICML, 2014; Karim Ali, et al., “Confidence-rated multiple instance boosting for object detection,” CVPR, pp. 2433-2400, 2014; Quannan Li, et al., “Harvesting mid-level visual concepts from large-scale internet images,” CVPR 2013.

While such techniques have been applied to the detection of objects, they have not been used for learning the structure of objects using only weak supervision. While unsupervised discovery of dominant objects using part-based region matching has been proposed (see, Minsu Cho, et al., “Unsupervised Object Discovery and Localization in the Wild: Part-based Matching with Bottom-up Region Proposals,” CVPR, 2015, hereinafter, “Cho 2015”) it is an unsupervised process, and thus is not suited to naming the discovered objects or matched regions. In deformable parts models (DPM), parts are often defined as a localized component with consistent appearance and geometry in an object, but without semantic interpretation. See, P. F. Felzenszwalb, et al., “Object detection with discriminatively trained part based models,” PAMI, 32(9):1627-1645, 2010.

Some part detection methods make use of strong annotations in the form of bounding boxes or segmentation masks at the part level. See, Ning Zhang, et al., “Part-based R-CNNs for fine-grained category detection,” ECCV, pp. 834-84, 2014; Xianjie Chen, et al., “Detect what you can: Detecting and representing objects using holistic models and body parts,” CVPR, 2014, hereinafter, “Chen 2014”; Peng Wang, et al., “Joint object and part segmentation using deep learned potentials,” ICCV, pp. 1573-1581, 2015. However, these approaches are manually intensive at training time.

There remains a need for a system and method for automatically detecting and naming both objects and their parts in images, using as little supervision as possible.

### INCORPORATION BY REFERENCE

The following references, the disclosures of which are incorporated herein by reference, are mentioned:

U.S. Pub. No. 20140270350, published Sep. 18, 2014, entitled DATA DRIVEN LOCALIZATION USING TASK-DEPENDENT REPRESENTATIONS, by Jose Antonio Rodriguez Serrano, et al.

U.S. Pub. No. 20100040285, published Feb. 18, 2010, entitled SYSTEM AND METHOD FOR OBJECT CLASS LOCALIZATION AND SEMANTIC CLASS BASED IMAGE SEGMENTATION, by Gabriela Csurka, et al.

### BRIEF DESCRIPTION

In accordance with one aspect of the exemplary embodiment, a method for generating object and part detectors includes accessing a collection of training images. The collection of training images includes images annotated with an object label and images annotated with a respective part label for each of a plurality of parts of the object. Joint appearance-geometric embeddings are generated for regions of a set of the training images; learning at least one detector for the object and its parts using annotations of the training images and the joint appearance-geometric embeddings. Information based on the object and part detectors is output.

At least one of the generating of the joint appearance-geometric embeddings, and the learning of the object and part detectors may be performed with a processor.

In accordance with another aspect of the exemplary embodiment, a system for labeling regions of an image corresponding to an object and its parts, includes memory which stores a detector for the object and detectors for each of a plurality of parts of the object. Each of the detectors has been learnt on regions of training images scoring higher than other regions on a scoring function which is a function of a joint appearance-geometric embedding of the respective region and a vector or parameters. The joint appearance-geometric embedding is a function of an appearance-based representation of the region and a geometric embedding of the region. The vector of parameters has been learned with multi-instance learning. A processor applies the detectors to a new image and outputs object and part labels for regions of the image.

In accordance with another aspect of the exemplary embodiment, a method for generating object and part detectors includes accessing a collection of training images, the training images including images annotated with an object label and images annotated with a respective part label for each of a plurality of parts of the object. A set of similar images in the collection is identified. The similar images are identified based on image representations of the images, at least some of the images in the set having a label in common. A set of regions is extracted from each image in the set. Appearance-based representations of the extracted regions are generated. For each of at least a subset of the set of the training images, an image transformation is generated which maps the respective training image to a common geometric frame. Based on the appearance-based representations of at least some of the regions of each training image and matching appearance-based representations of at least one of the other images in the set, geometric embeddings of at least a subset of the extracted regions from each image are generated with the respective learned transformation. Joint appearance-geometric embeddings for regions in the subset of the extracted regions of the training images are generated based on the respective appearance-based representation and geometric embedding. A parameter vector is learned with multi-instance learning for weighting joint appearance-geometric embeddings in a scoring function. Regions of training images having scores generated by the scoring function that are higher than for regions of images which do not have the common label are identified. Detectors are learnt for the object and its parts using representations of the identified regions.

At least one of the steps of the method may be performed with a processor.

### BRIEF DESCRIPTION OF THE DRAWINGS

FIG. 1 illustrates object detection for person and car semantic categories in an image;

FIG. 2 illustrates detection of objects and object parts in the semantic category person;

FIG. 3 illustrates detection of objects and object parts in the semantic category car;

FIG. 4 is a functional block diagram of a system for training a model for object/part detection in accordance with one aspect of the exemplary embodiment;

FIG. 5 illustrates mapping regions of images to a template;

FIG. 6, which is split into FIGS. 6A and 6B for ease of illustration, illustrates a method for training a model for object/part detection in accordance with another aspect of the exemplary embodiment;

FIG. 7 illustrates learning of the scoring function in the method of FIG. 6;

FIG. 8 illustrates an undirected graph for images with similar parts;

FIG. 9 illustrates alignment of two object instances in similar images for learning part variability;

FIG. 10 shows example detections obtained by a baseline MIL method with one annotation (B+A); and

FIG. 11 shows example detections obtained by a baseline MIL method adapted with contextual and geometric information and with one annotation (B+A+C+G).

### DETAILED DESCRIPTION

Aspects of the exemplary embodiment relate to a system and method for localization of objects and their parts in images and to name them according to semantic categories. The exemplary method provides for joint object and part localization, and may find application in a variety of enhanced computer vision applications.

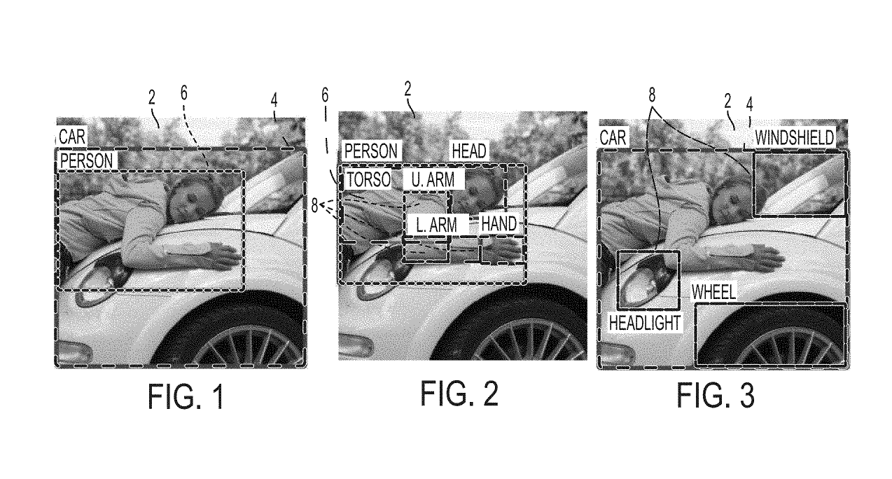

The aim of the method is illustrated in FIGS. 1-3. FIG. 1 illustrates a conventional object localization in an image 2. Given car and person categories, only crude information is provided about the objects 4, 6, in the image 2, i.e., the predicted locations of the car and the person. In FIGS. 2 and 3, which are modeled as object parts and geometry, more detailed information is extracted for both detected objects 4, 6 and their parts 8. For example, in the person image, the parts head, upper arm, torso, lower arm, and hand have been recognized. This information can provide a more informative understanding of the scene.

While FIGS. 2 and 3 show the regions where the parts and objects are predicted to be located as rectangular bounding boxes, in the exemplary embodiment, the regions can alternatively be other regular geometric shapes, non-regular (e.g., freeform) shapes, or keypoints (denoting the geometric center of a predicted region encompassing the object or object part).

In the exemplary method, instead of simply considering parts as localized information that can improve object recognition, object parts are considered as object categories in their own right. The method reasons jointly about appearance and geometry using a joint embedding, which improves detection.

The concept of “part” is modeled as a relation between object types, where object categories (e.g., “face”) and part categories (e.g., “eye,” “mouth”) are treated on an equal footing and modeled generically as visual objects. This allows building detectors for both objects and nameable object parts. In the training phase, the exemplary system and method jointly learns about objects, their parts, and their geometric relationships, using little or no supervision.

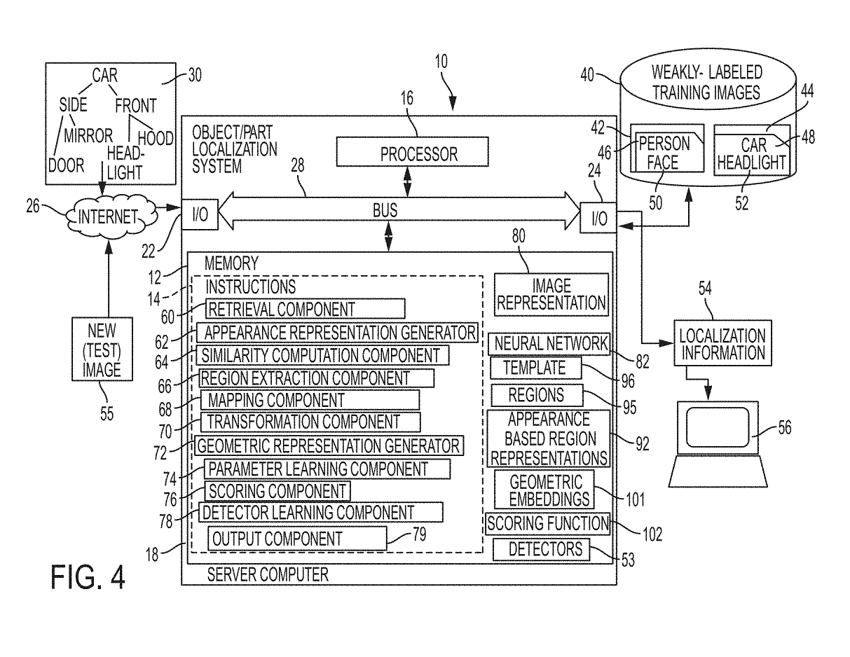

FIG. 4 illustrates an exemplary system 10 for learning an object and part localization model and/or for using such a model. The system 10 includes memory 12 which stores instructions 14 for performing the exemplary method and a processor 16 in communication with the memory for executing the instructions. The system may be hosted by one or more computing devices 18 such as the illustrated server computer. One or more input/output devices 22, 24 allow the system to communicate with external devices, e.g., via wired or wireless links 26, such as a local area network or the Internet. Hardware components 12, 16, 22, 24 of the system communicate via a data/control bus 28.

The system is provided with relationship information 30 for a set of object categories. In particular, for each object category of interest, the category name and the names of at least some of its semantic parts are provided. This information may be in the form of an ontology (a graph), in which the object serves as a root node and the parts as its child, grandchild, etc. nodes, which are linked, directly or indirectly, to the root by edges.

The system 10 has access to or retrieves a collection 40 of annotated images (annotated at the image level), each image 42, 44 having one or more object category labels 46, 48, and/or one or more part category labels 50, 52, etc. for object/part categories of interest. These labels are associated with the entire image, rather than with specific regions of the image, thus providing the information that the image is expected to contain one or more objects/parts corresponding to the label(s), but the locations of these objects/parts in the respective image are unspecified.

In some embodiments, the system may output object and object part detectors 53 learned using the annotated images. In some embodiments, the system 10 may output localization information 54 for a new image 55 to an output device 56, such as a display device or printer. The display device may be linked directly to the computer or may be associated with a separate computing device that is linked to the computer via the network 26.

The exemplary software instructions 14 include a retrieval component 60, an appearance representation generator 62, a similarity computation component 64, a region extraction component 66, a mapping component 68, a transformation computation component 70, a geometric representation generator 72, a parameter learning component 74, a scoring component 76, a detector learning component 78, and an output component 79.

The retrieval component 60 receives the information 30 including the set of object categories and respective part categories. Given the set of object categories and respective part categories, the retrieval component accesses a collection 40 of images and retrieves training images 42, 44, etc., whose label(s) match one or more of the set of object and part categories. In another embodiment, a small set of manually-labeled training images is provided.

The appearance representation generator 62 generates an image level representation 80 (image descriptor) for each training image 42, 44, etc., based on the pixels of the image. In one embodiment, the representation 80 may be generated with a trained neural network 82, although other representations may be used, such as Fischer vector-based representations, or the like.

The similarity computation component 64 identifies sets of similar images based on the similarity of their representations and the relationships between their labels.

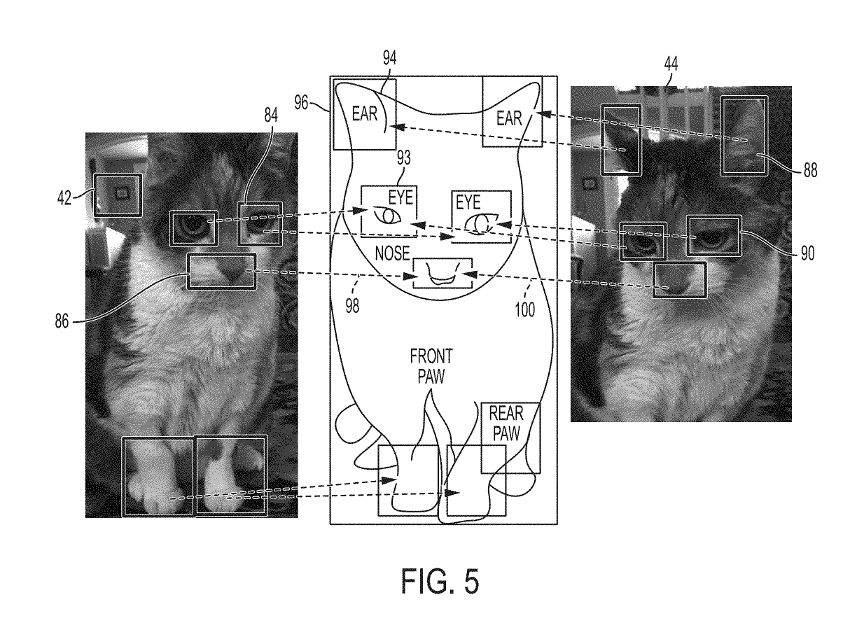

The region extraction component 66 extracts a set of regions 84, 86, 88, 90, etc. from each image in each of the pairs (sets) of images (FIG. 5).

The representation generator 62 (or a separate representation generator) generates an appearance-based region-level representation 92 for each region, based on the pixels of the region.

The mapping component 68 maps extracted regions 84, 86, 88, 90 to planar regions 93, 94 of a common frame or “template” 96.

The transformation component 70 generates transformations (indicated by dashed arrows 98, 100 etc.) for the mapped regions 84, 86, 88, 90 of the paired images to the corresponding regions 93, 94, etc. of the template 96 and generates an image-level transformation for each image.

The geometric representation generator 72 generates geometric representations (geometric embeddings) 101 of image regions using the image-level transformation. The parameter learning component 74 learns for each category, parameters for a scoring function 102 which combines the geometric and appearance representations. The scoring component 76 scores regions with the scoring function 102. The detector learning component 78 learns detectors 53 for detecting an object and its parts using regions identified with the scoring function. The output component outputs information such as the detectors 53 and/or object/part labels applied by the detectors to a new image 55.

The computer system 10 may include one or more computing devices 18, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 16 and memory 12 may be combined in a single chip. Memory 12 stores instructions for performing the exemplary method as well as the processed data.

The network interface 22, 24 allows the computer to communicate with other devices via a computer network, such as a local area network (LAN) or wide area network (WAN), or the internet, and may comprise a modulator/demodulator (MODEM) a router, a cable, and/or Ethernet port.

The digital processor device 16 can be variously embodied, such as by a single-core processor, a dual-core processor (or more generally by a multiple-core processor), a digital processor and cooperating math coprocessor, a graphics processing unit (GPU), a digital controller, or the like. The digital processor 16, in addition to executing instructions 14 may also control the operation of the computer 18.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

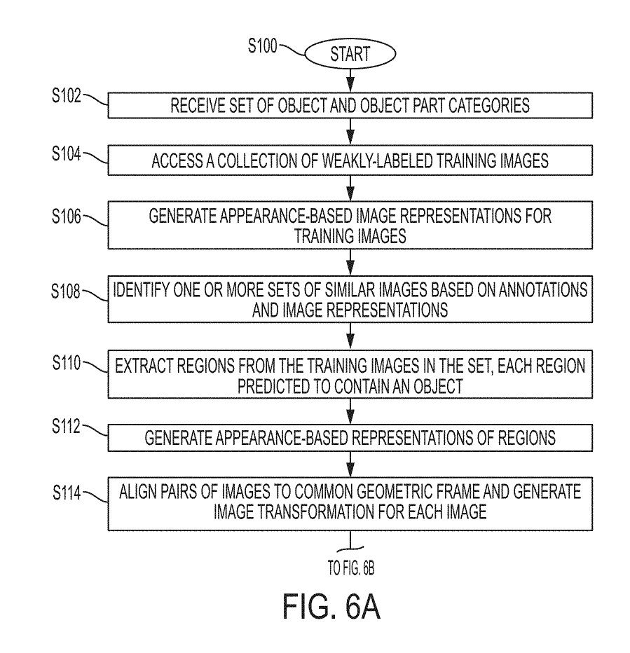

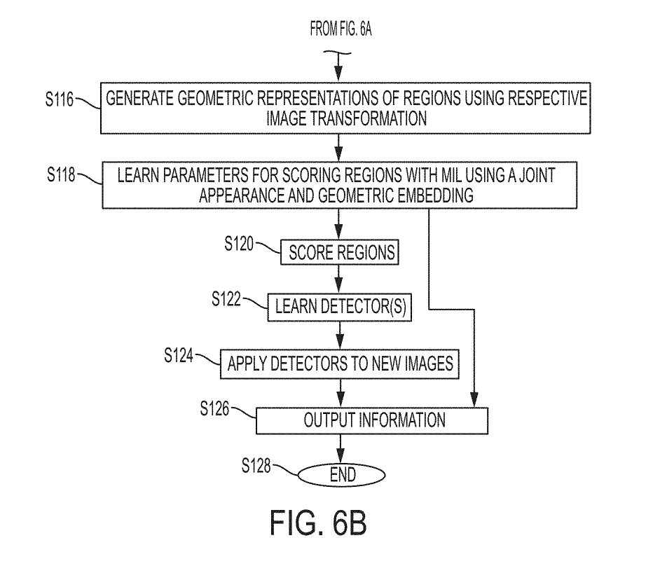

With reference now to FIG. 6, which is split into FIGS. 6A and 6B for ease of illustration, a method for extracting localization information for objects and their parts which can be performed with the system of FIG. 4 is shown. The method begins at S100.

At S102, a set of object and object part categories 30 is received which identifies the relationship between a visual object and its respective parts.

At S104, images 40 with respective labels which match the object and part categories are retrieved. The images may have no localization information for the objects corresponding to the label or even any guarantee that the object is present in the image.

At S106, multi-dimensional appearance-based image representations 92 are generated for the retrieved images, by the appearance representation generator 62.

At S108, sets of similar images are identified, based on their labels and image representations, by the similarity computation component 64.

At S110, regions 84, 86, 88, 90 predicted to contain an object or a semantic part of an object are extracted from pairs of the similar images 42, 44, by the region extraction component 66.

At S112, multi-dimensional appearance-based region representations 92 are generated, by the appearance representation generator 62, for the regions 84, 86, 88, 90, etc. extracted from each image in a pair of similar images. Each appearance-based region representation 92 is a representation of only a part of the respective image 42, 44 that is predicted to contain an object of any kind.

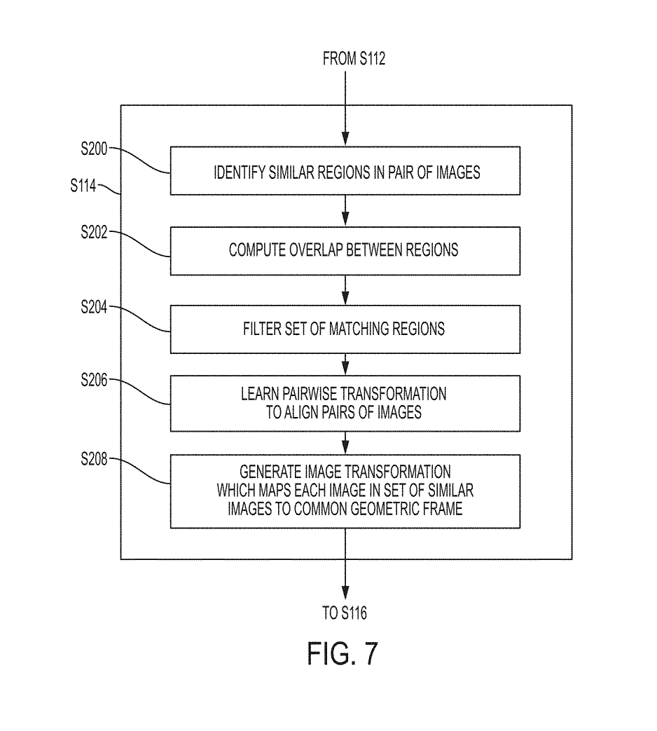

At S114, pairs of images are aligned to a common geometric frame 96 to learn a transformation for embedding regions of an image to the geometric frame, as described with reference to FIG. 7.

At S116, geometric embeddings 101 of image regions are computed using the transformation learned at S114, by the geometric representation generator.

At S118, parameters for scoring image regions are learned, by the parameter learning component 74, based on the appearance-based region representations 92 and geometric embeddings 101 of positive and negative regions for each category, using MIL.

At S120, regions are scored with the scoring function 102 to identify high scoring regions for learning a detector (or detectors) for the object and its parts.

At S122, one or more object and part detectors 53 is/are learned for each category using at least some of the highest scoring regions from the images labeled with the corresponding object or part category.

At S124, the detector(s) 53 may be applied to a test image 55 to predict regions corresponding to objects and object parts in the test image.

At S126 information is output.

The method ends at S128.

Further details on the system and method will now be provided.

### Definition of Semantic Categories (S102)

The object categories and part categories depend on the type of images being processed, the categories sought to be recognized, and the quantity of training samples available. For example, for the category car, a set of part categories may be defined, such as wheel, headlight, windshield, and so forth. Each part is thus less than the whole object. The number of part categories is not limited, and can be, for example, at least two, or at least three, or at least five, or at least ten, or up to 100, depending on the application. The parts can, themselves, have parts, for example the part car front may have parts such as headlight, hood, windscreen, and so forth. The relationships between the categories are known, such as windscreen is a part of car front, car front is a part of car. The object and parts to be recognized may be specified by a user or may be retrieved automatically from a previously generated ontology for the object.

The system 10 may store this relationship information 30 in memory 12.

### Image Retrieval (S104)

For retrieval of training images 40, the exemplary method does not require precise labeling of objects of interest and their parts with bounding boxes or other types of region, but can be implemented with annotations only at the image-level. Listing all the visible semantic parts in the training images may still be a time-consuming process if performed manually from scratch. In order to overcome the need for manually-labeled training examples for objects and their semantic parts, labeled training examples 40 for objects and their semantic parts may be obtained by extracting weak information in an automatic manner from the Internet. To obtain the web images, an image search engine, such as Google or Bing, can be used to retrieve images for each object category, and each object part category. In this way, a noisy set of images is retrieved that is weakly biased towards the different semantic categories to be detected. The labels of the retrieved images may have been generated automatically, for example, based on surrounding text, using image categorization methods, combination thereof or the like by proprietary algorithms employed by the search engines. As will be appreciated, some of the retrieved images may not necessarily include the object or part, but in generally, there will be at least some images in the retrieved set that do. These sets of weakly-labeled images are used jointly to learn the detectors. This weakly-supervised approach scales very easily.

The weak information about objects and object parts is extracted from the Web as follows. Given an object category (e.g., “car”) and a hierarchy of parts (e.g., “car front,” “car rear”) and optionally subparts (e.g., “headlight,” “car window,” etc.), all of which can be considered as concepts, queries related to each concept are submitted to an Internet image search engine to retrieve corresponding example images, typically resulting in a few hundred noisy examples per object/part. The level of specifying the object or object part in the query may depend, in part, on the type of object/part. For example, for the category nose, it likely would not be necessary to specify face nose, since few other objects have a nose, and over-specification may reduce the number of images retrieved.

In some embodiments, one or more hard annotations (i.e., region annotations, such as bounding box annotations) may be available for one or more images and these images may be incorporated into the training set.

### Generation of Representations of Images (S106)

Image representations (global image descriptors φ^{a}(xᵢ)) 80 are extracted from all the retrieved images xᵢ ∈ χ, where χ is the set 40 of retrieved images. The exemplary image descriptors are multi-dimensional vectors of a fixed dimensionality, i.e., each image descriptor has the same number of elements.

The image descriptors 80 may be derived from pixels of the image, e.g., by passing the image 40 through several (or all) layers of a pretrained convolutional neural network, to extract a multi-dimensional feature vector, such as activation features output by the third convolutional layer (conv3) in AlexNet. See, Alex Krizhevsky, et al., “ImageNet Classification with Deep Convolutional Neural Networks,” NIPS, pp. 1097-1105, 2012. Other methods for extracting image descriptors from neural networks are described, for example, in U.S. application Ser. No. 14/793,434, filed Jul. 7, 2015, entitled EXTRACTING GRADIENT FEATURES FROM NEURAL NETWORKS, by Albert Gordo Soldevila, et al.; U.S. application Ser. No. 14/691,021, filed Apr. 20, 2015, entitled FISHER VECTORS MEET NEURAL NETWORKS: A HYBRID VISUAL CLASSIFICATION ARCHITECTURE, by Florent C. Perronnin, et al., the disclosures of which are incorporated herein by reference in their entireties.

Other methods for extracting image descriptors 80, such as those using Fisher vectors or bag-of-visual-word representations based on SIFT, color, texture and/or HOG descriptors of image patches, are described, for example, in U.S. Pub. Nos. 20030021481; 2007005356; 20070258648; 20080069456; 20080240572; 20080317358; 20090144033; 20090208118; 20100040285; 20100082615; 20100092084; 20100098343; 20100189354; 20100191743; 20100226564; 20100318477; 20110026831; 20110040711; 20110052063; 20110072012; 20110091105; 20110137898; 20110184950; 20120045134; 20120076401; 20120143853; 20120158739; 20120163715; 20130159292; 20140229160; and 20140270350, the disclosures of which are incorporated herein by reference in their entireties.

The region representations 92 can be generated in the same manner as the image representations 80, or using a different type of multidimensional representation, as described below for S112.

Each multi-dimensional descriptor 80, 92 may include at least 10, or at least 20, or at least 50, or at least 100 dimensions.

### Identifying Similar Images (S108)

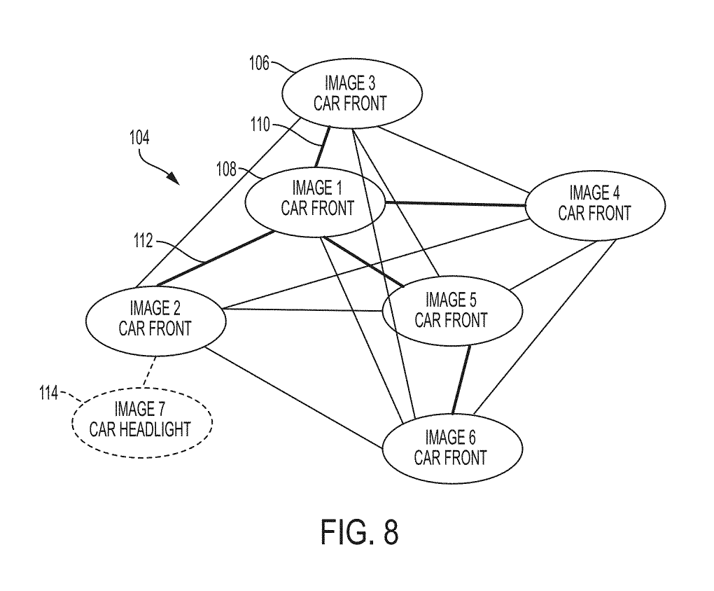

For efficiency, to identify similar images, the similarity computation component 64 builds a shortlist E of image pairs to consider as candidates for alignment in the form of a minimum spanning tree (MST). To build the list E, an undirected graph 104 (FIG. 8) is first built in which images having at least one object and/or part category in common (based on their labels) form nodes 106, 108, etc. (shown with solid ovals), and where edges 110, 112, etc. represent distances between the images. The distances are computed based on the image representations 80 computed at S106. Various distance measures can be used for computing similarity, such as the Euclidean distance, Mahalanobis distance, or the like. In one embodiment, the distance between two images, denoted xᵢ and xⱼ is computed as an inverse exponential function of the product of their respective representations φ^{a} (xᵢ) and φ^{a}(xⱼ), e.g., using the equation dᵢⱼ=e^{-φ}^{^{a}}^{(x}^{ᵢ}⁾^{^{T}}^{φ}^{^{a}}^{(x}^{ⱼ}⁾, where T denotes the transpose.

Then, E is defined as a minimum spanning tree (MST) over the fully connected graph 104 that has the pairwise scores dᵢⱼ=e^{-φ}^{^{a}}^{(x}^{ᵢ}⁾^{^{T}}^{φ}^{^{a}}^{(x}^{ⱼ}⁾ as edge weights. The MST is the one which connects all the nodes as a tree and which has the minimal total weighting for its edges. The MST is illustrated in FIG. 8 by the bold edges which connect all the nodes such that every node, except the root 108, has exactly one parent node, and has 0, 1, or more child nodes. Methods for computing an MST include Prim's algorithm and Kruskal's algorithm. See, also, Pettie, et al., “An optimal minimum spanning tree algorithm,” J. Assoc. for Computing Machinery, 49 (1): 16-34 (2002). The set E may be augmented with a set of nearest neighbors 114 (an example is shown with a dashed oval), such as the at least one, or at least five, ten, or more nearest neighbors of each image within each “relevant” query set. In this case, “relevant” encompasses the image's own set in the MST, the set obtained for the parent class, and/or the sets of the children classes. For example, relevant sets for face images are face, eye, eyebrow, mouth, and nose query results, for eye, those are face and eye results. The nearest neighbors can be identified using the same distance measure used for computing dᵢⱼ.

The appearance of object parts is highly variable and Web annotations for parts are extremely noisy. This problem is addressed by leveraging distributed representations of geometry. Given a noisy collection of images weakly biased towards different concepts (e.g., “face,” “eye,” “mouth”), the search and similarity computation identifies image pairs that have a strong overall similarity but that can differ locally. The advantage of such images is that they can be identified before an object model is available by using generic visual cues. Their alignment can help learn the variability of parts. The pairs identified at S108 from an MST are used to extract noisy geometric information from the data, which is then used to define a joint appearance/geometric embedding. This distributed representation can be used to jointly reason about object appearance and geometry and improves the training of detectors.

One difficulty is that querying Internet search engines for object parts often produces only a small number of clean results, with the majority of images containing the whole object (or noise) instead. Current algorithms for weakly-supervised detection are confused by such data and fail to learn parts properly. In order to disambiguate parts from objects and to locate them successfully in a weakly-supervised scenario, using powerful cues such as the geometric structure of objects is advantageous. However, geometry is difficult to estimate robustly in object categories, particularly if little or no prior information is available.

The exemplary method addresses these challenges by introducing a geometry-aware variant of multiple instance learning (MIL). This includes constructing an embedding to represent geometric information robustly, and extracting geometric information from pairwise image alignments.

### Region Extraction (S110)

The region extraction component 66 may utilize a suitable segmentation algorithm(s) designed to find objects within the pairs of images identified at S108. The objects that are found in this step may or may not be in any of the object or part categories, but are simply recognized as each being an arbitrary object. An advantage of this approach is that it avoids using a sliding-window approach to search every location in an image for an object. However, sliding window approaches for extracting regions may be used in some embodiments. The exemplary segmentation algorithm produces a few hundred or a few thousand regions that may fully contain an arbitrary object. Algorithms to segment an image which may be used herein include selective search (See, for example, J. R. R. Uijlings, et al., “Selective search for object recognition,” IJCV, 104(2), 154-171, 2013; van de Sande, et al, “Segmentation as Selective Search for Object Recognition,” 2011 IEEE Int'l Conf. on Computer Vision), and objectness (e.g., Cheng et al, “BING: Binarized Normed Gradients for Objectness Estimation at 300 fps,” IEEE CVPR, 1-8, 2014).

The regions produced can be regular shapes, e.g., rectangles of the smallest size that encompass the respective arbitrary objects, or irregular shapes, which generally follow the contours of the objects.

### Generation of Appearance-Based Representations of Regions (S112)

For each extracted region, an appearance-based representation 92 is computed (S112). The appearance-based region representations, denoted φ(xᵢ|R), may be computed in the same manner as the global representations φ^{a}(xᵢ), but using only the pixels within the region (or within patches which at least overlap the region). In one embodiment, the region representations are extracted from a CNN, e.g., features of fc6 (fully-connected layer 6) extracted from AlexNet, similar to R-CNN. See, Ross Girshick, et al., “Rich feature hierarchies for accurate object detection and semantic segmentation,” CVPR, 2014, hereinafter, Girshick 2014. The location of the region in the image is also stored, such as its geometric center.

### Aligning Images to Find Matching Regions and Map to Common Geometric Frame (S114)

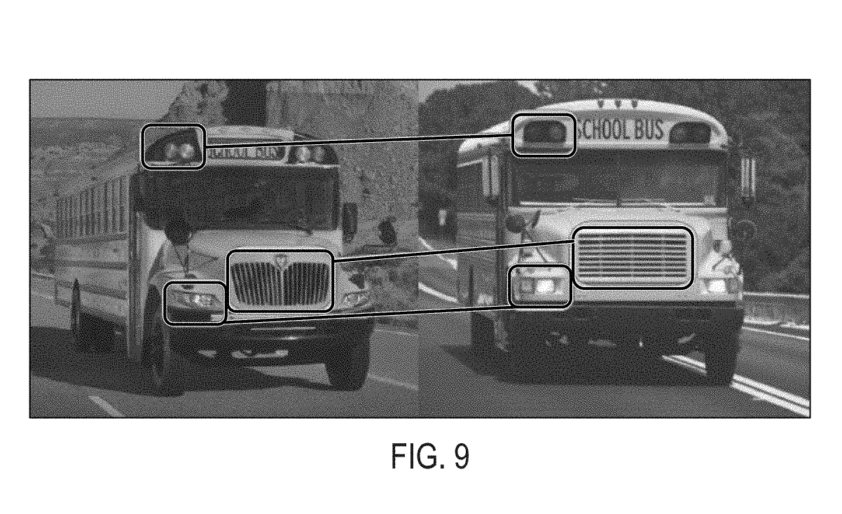

Next the object/part hierarchy and corresponding example images are used to extract geometric information from the data. As illustrated in FIG. 9, this is achieved by looking for similar images that are related by simple transformations. While these two object instances may look very similar overall, individual parts look very different. Hence by aligning such images this can help to learn the part variability.

This step includes learning a transformation to align pairs of images previously identified at S108, denoted (x′,x″)∈ E by finding matching regions, and mapping them to a common geometric frame 96.

Let R ∈ x′ and Q ∈ x″ be image regions of the images in the pair extracted at S110. Let φ^{a}(R)=φ^{a}(x′|R) and φ^{a}(Q)=φ^{a}(x″|Q) denote visual region descriptors computed for each region at S112.

S114 may proceed as follows.

At S200, the appearance-based region descriptors 92 are used to match regions in the first image x′ to regions in the second x″. For each region R the best match Q* in image x″ is identified as being the one with the most similar appearance-based region descriptor: Q*(R)=argmax_{Q∈x″} [symbol] φ^{a}(R), φ^{a}(Q) [symbol] . Matches may be verified by repeating the operation in the opposite direction, obtaining R*(Q). This results in a shortlist of candidate region matches M={(R, Q):R*(Q*(R))=R [symbol] Q*(R*(Q))=Q} that map back and forth consistently based only on the comparison of appearance-based region descriptors.

At S202, overlap between an image region R and region Q is computed. The overlap of regions R and Q can be computed, for example, by the Intersection over Union measure: IoU(R,Q)=|R ∩ Q|/|R ∪ Q|. Mathematically, regions can be written as indicator functions, e.g., the indicator function of R is given by R(x,y)=H(x−x₁)H(x₂−x)H(y−y₁)H(y₂−y), where H(z)=[z≧0] is the Heaviside function. Then, |R ∩Q|=∫R(x,y)Q(x,y)dx dy.

The standard IoU measure can be relaxed to provide a more permissive geometric similarity measure between regions R and Q. To do so, let R be a bounding box of extent [x₁,x₂]×[y₁,y₂]. The relaxed version of IoU can be obtained by replacing the Heaviside function H with the scaled sigmoid H_{ρ}(z)=exp(ρz)/(1+exp(ρz)). This relaxed version allows bounding boxes to have non-zero overlap even if they do not intersect.

Both the standard IoU and its relaxed version are positive definite kernels, as described in further detail below.

At S204, the set M of matching regions may be filtered. While several matches in M are good, the majority are outliers. These may be removed by using a NOSAC-style filtering procedure. See, for example, James Philbin, et al., “Object retrieval with large vocabularies and fast spatial matching,” CVPR, 2007. In an exemplary embodiment, each region pair (R, Q)∈ M is used to generate a transformation hypothesis T by fitting an affine transformation to map R into Q (i.e., Q≈TR), resulting in a candidate set [symbol] of possible pairwise transformations T. Each hypothesis T is then scored as a function of a measure of the overlap (e.g., intersection over union, IoU) between each region R of x′, as transformed by the transformation, and the corresponding region Q in image x″ and the overlap between each region Q in image x″ as transformed by the pairwise transformation, and the corresponding region R of x′, e.g., as:

S(T)=Σ_{(R,Q)∈M} max{0,IoU(TR, Q)−δ}+max{0,IoU(R, T⁻¹Q)−δ} (1)

where δ is a minimum overlap threshold for a match to count as correct.

The score S(T) of a given pairwise transformation is thus a soft count of how many region matches in M are compatible with the pairwise transformation T (inliers).

At S206, the best hypothesis T*=argmax_{T∈} [symbol] S(T) is then selected and then further refined by fitting a final pairwise transformation Tᵢⱼ to the set of all inliers of T* (those matches with at least a threshold overlap when transformed with the transformation in each direction).

At S208, given the pairwise transformations Tᵢⱼ, (i,j)∈ E, for each image, a single image transformation Tᵢ is found that summarizes the relation of that image to the others in the MST. To do this, transformations are decomposed as Tᵢⱼ≈Tᵢ ∘ Tⱼ⁻¹, where Tᵢ corresponds to aligning image xᵢ to a common geometric frame 96 and Tⱼ corresponds to aligning another image to the common geometric frame 96. This decomposition is performed globally for all the images by minimizing:

(T*₁, . . . , T*ₙ)=argmin_{T}_{₁}_{, . . . , T}_{ₙ} Σ_{(i,j)∈E} S(Tᵢⱼ)∥Tᵢⱼ−Tᵢ ∘ Tⱼ⁻¹∥. (2)

Several distance measures could be used, such as the L₁ distance of the vectorized matrices. This energy can be minimized e.g., using stochastic gradient descent with momentum.

In this way, all images in the set ∈ are mapped to the common frame 96 by a respective planar transformation Tᵢ. These transformations cannot directly account for out of plane rotations of 3D objects. However, this is not a problem as, by taking the product of the appearance and geometric embeddings in multi-instance learning, this implicitly allows transformations to be valid only conditioned on the appearance of the regions (and vice-versa).

### Geometric Embedding (S116)

The goal of geometric embedding is to transform a projection in the common embedding; Q; into a representation vector with finite dimension. One way to do so is to assume that a set of representative vectors, that can be used to describe the common reference frame, are available. Then the geometric embedding is described using these representatives. In practice, a number, e.g., at least 10 or at least 20 or 100, or more representatives are selected after each relocalization round. The set of positive part relocalizations is split into 100 (or other number of representatives that is chosen) clusters based on their distance in the overall kernel space using spectral clustering. Each cluster's representative is then a mean (or median) of a bounding-box of its members, or other strategies could be applied to identify the representative, based on the members of the cluster. Constant embedding are set for negative samples as the mean over the embedding vectors of all positive samples.

The geometric embedding is denoted φ^{g}(Tᵢ⁻¹Rᵢ), which is the transformation of region R of an image onto the template 96 using the transformation Tᵢ. Let Q=Tᵢ⁻¹R be a planar region with the highest visual similarity to a region R with Q ⊂ [symbol] ², so that this problem reduces to constructing an embedding for regions.

Given a positive definite kernel on regions, a geometric embedding φ^{g}(Q)∈ [symbol] ^{m} can be defined. In order to make the embedding finite dimensional, a set of representatives Z=(Q₁, . . . , Qₘ) is considered and Q is projected on it:

$${φ}^{g} ( Q ) = {K}_{ZZ}^{- \frac{1}{2}} {K}_{ZQ} ,$$

where K_{ZZ} ∈ [symbol] ^{m×m} and K_{ZQ} ∈ [symbol] ^{m×1} are the kernel matrices comparing regions as indicated by the subscripts, e.g., K_{ZZ}(i,j)=K(Qᵢ,Qⱼ). Geometrically, this corresponds to projecting Q on the space spanned by Q₁, . . . , Qₘ in kernel space. Alternatively, note that φ^{g}(R)^{T}φ^{g}(Q)=K_{RZ}K_{ZZ}⁻¹K_{ZQ}≈K_{RQ}.

In practice, the representations may be sampled after every MIL relocalization round from the set of positive examples using, for example, spectral clustering in the geometric kernel space.

This abstract construction has a simple interpretation. Roughly speaking, φ^{g}(Q) can be thought of as an indicator vector indicating which of a set of reference regions Q₁, . . . , Qₘ is close to Q.

Learning Parameters of Scoring Function for Scoring Regions with Geometry-Aware Multiple Instance Learning (MIL) (S118)

S118 includes, for each category (object and each part) assembling positive and negative training samples from the extracted regions 84, 86, 88, 90, etc., of the similar images. Then, the geometric embeddings and appearance representations of these regions are used to learn a set of parameters for weighting the features of the geometric embeddings (or the features of the appearance representations) in a scoring function 102. The parameter learning is performed with Multiple Instance Learning, as described below.

A general description of Multiple Instance Learning (MIL) for performing object detection is found in Thomas G. Dietterich, et al., “Solving the multiple instance problem with axis-parallel rectangles,” Artificial Intelligence, 89(1-2):31-71, 1997. The baseline MIL (MIL Baseline) is first described followed by an adaptation of the method to incorporate geometric information.

MIL Baseline Method

Let xᵢ be an image in a collection of n training images and let [symbol] (xᵢ) be a shortlist 95 of image regions extracted from the image xᵢ by the region proposal mechanism, such as selective search.

Each image xᵢ for i=1 to n belongs either to a positive set i ∈ χ₊, in which case at least one region R ∈ [symbol] (xᵢ) corresponds to the object and is positive, or to a negative set χ_, in which case all regions are negative.

Each region R in the set [symbol] (xᵢ) is assigned a score Γ(xᵢ,R|w)= [symbol] φ(xᵢ|R), w [symbol] , i.e., the scalar product of φ(xᵢ|R) and w, where w is a vector of parameters and φ(xᵢ|R)∈ [symbol] ^{d} is the appearance representation 92 describing region R in image xᵢ. Each element in w thus weights a respective one of the features in the region representation. The aim is to find the region R with the highest score Γ(xᵢ,R|w) in each image which matches the label of that image.

The parameters in vector w can be learned by fitting an optimization function to the data as follows:

$${min}_{w ∈ {ℝ}^{d}} \frac{λ}{2} {‖ w ‖}^{2} + \frac{1}{n} {\sum }_{i = 1}^{n} max \{ 0 , 1 - {y}_{i} {max}_{R ∈ ℛ ( {x}_{i} )} Γ ( {x}_{i} , R \vert w ) \} \qquad ( 3 )$$

where the label yᵢ=+1 if i ∈ χ₊ and yᵢ=−1 otherwise,

$$\frac{λ}{2} {‖ w ‖}^{2}$$

is a regularization parameter which is a function of w and a constant value

$$\frac{λ}{2} ,$$

which is non-zero in the exemplary embodiment and can be determined through experimentation, and

n is the number of images.

The optimization function in Eqn. 3 finds the vector w which minimizes an aggregate of the regularization parameter and a sum, over all images, of the maximum of zero and the maximum region score, given w, which is added to one for negative samples and subtracted from one for positive samples. Eqn. 3 is thus designed to provide a parameter vector w which is more likely to give one or more of the regions from an image in the positive set (which are labeled with the object/part) a higher score than given to any of the regions from images in the negative set (which are not labeled with the object/part).

In practice, Eqn. (3) may be optimized by alternating selecting of the maximum scoring region for each image (also known as “re-localization”) and optimizing w for a fixed selection of regions. For the MIL baseline method, φ=φ^{a}, where φ^{a}(x|R)∈ [symbol] ^{d}^{ₐ} is a descriptor 92 of the region's appearance and is the only information used. Over a series of iterations, the MIL method should automatically learn to pick the image regions that are more predictive of a given object class and which, therefore, should correspond to the object. However, MIL may, in practice, fail to recognize meaningful or consistent regions, instead, focusing on regions which neither correspond to the object as a whole nor to one of its parts.

Geometry-Aware (MIL)

In order to improve the stability of region selection in MIL, the baseline method is adapted to incorporate geometric information capturing the overall structure of an object.

In one embodiment, when learning a part, the appearance descriptor φ^{a}(x|R)∈ [symbol] ^{d}^{ₐ} of each region is augmented with a descriptor of the surrounding region, with the aim of capturing the overall appearance of the object and using the surrounding region as context.

In the exemplary embodiment, alignment of pairs of images in the dataset can provide strong clues for part learning. From such pairwise alignments, transformations Tᵢ can be extracted that tentatively align each image xᵢ to an object-centric coordinate frame (template) as described above (S114). This information can be incorporated into MIL efficiently and robustly, as described in further detail below.

Joint distributed embeddings can be used to combine robustly different sources of information. For example, it has been employed to combine visual and natural language cues in A. Frome, et al., “Devise: A deep visual-semantic embedding model,” NIPS, pp. 2121-2129, 2013. In a similar manner, a joint embedding space can be used where visual and geometric information can be robustly combined to understand objects and their parts. In particular, a geometric embedding φ^{g}(Tᵢ⁻¹R)∈ [symbol] ^{d}^{_{g}}, as described above, can be employed that maps the noisy alignment Tᵢ estimated for image xᵢ to a feature vector. This geometric embedding 101 can then be incorporated in MIL by replacing the appearance term φ^{a}(x|R) 92 with a joint appearance-geometric embedding:

φ(xᵢ|R, Tᵢ)=φ^{a}(xᵢ|R) [symbol] φ^{g}(Tᵢ⁻¹R) (4),

where [symbol] is the Kronecker product (or other aggregating function).

Alternatively, other functions for aggregating the appearance descriptor with geometric information are contemplated. In Eqn. 4, geometry and appearance are not weighted with respect to each other. This is not necessary in the present case since the MIL method adapts to find the best parameters.

This formula can also be seen as considering the product of the appearance kernel φ^{a}(xᵢ|R)^{T}φ^{a}(xᵢ|R) and geometric kernel φ^{g}(Tᵢ⁻¹R)^{T}φ^{g}(Tᵢ⁻¹R) generated by the corresponding embeddings.

The joint embeddings φ(xᵢ|R, Tᵢ) are used for learning a scoring function 102 of the form Γ(xᵢ|R, Tᵢ)= [symbol] φ^{a}(x|R) [symbol] φ^{g}(Tᵢ⁻¹R),w [symbol] , i.e., the scalar product of the joint appearance-geometric embedding and parameter vector w, that depends both on a region local appearance as well as the weak alignment information, relating image, region, and transformation.

As described for the baseline method, the parameters in vector w can be learned by fitting an optimization function to the data:

$${min}_{w ∈ {ℝ}^{d}} \frac{λ}{2} {‖ w ‖}^{2} + \frac{1}{n} {\sum }_{i = 1}^{n} max \{ 0 , 1 - {y}_{i} {max}_{R ∈ ℛ ( {x}_{i} )} Γ ( {x}_{i} , R \vert w ) \} \qquad ( 3 )$$

where the label yᵢ=+1 if i ∈ χ₊ and yᵢ=−1 otherwise, but where the score is computed with the joint embedding.

In one embodiment, MIL learning of the parameters w is first performed for a number of iterations with the appearance representations but not the geometric embeddings. Then, the parameters w are fine-tuned with one or more MIL iterations that use the geometric information.

By combining the geometric and appearance embeddings φ^{a}(x|R) and φ^{g}(Q), MIL learns a family of classifiers that recognize different portions of an object, as specified by Q, implicitly interpolating between m portion-specific classifiers.

### Incorporating Strong Annotations in MIL

Sometimes it is beneficial to combine the extremely noisy annotations obtained from Web supervision with a small amount of strongly supervised annotations, such as manually-generated, labeled bounding boxes. MIL can be modified to incorporate one or more single strongly-annotated examples.

In order to do this, the region scores Γ(xᵢ, R|w) may be weighed by the similarity between φ^{a}(xᵢ|R) and the appearance descriptor of the annotated example. Let Rₐ be the annotated region and xₐ its origin image. Then Γ(xᵢ, R|w) in Eq. 1 is replaced with \hat{Γ}(xᵢ, R|w), which is defined as:

$$\hat{Γ} ( {x}_{i} , R ; w ) = ( \begin{matrix}\frac{1}{c} Γ ( {x}_{i} , R \vert w ) {e}^{β 〈 {φ}^{a} ( {x}_{i} \vert R ) , {φ}^{a} ( {x}_{a} \vert {R}_{a} ) 〉} & {y}_{i} = 1 \\ Γ ( {x}_{i} , R \vert w ) & {y}_{i} = - 1\end{matrix} \\ where C = \frac{1}{\vert {χ}_{+} \vert} {\sum }_{\{ i ; {x}_{i} ∈ {χ}_{+} \}} {e}^{β 〈 {φ}^{a} ( {x}_{i} \vert R ) , {φ}^{a} ( {x}_{a} \vert {R}_{a} ) 〉} \qquad ( 5 )$$

is a normalization constant, and β=10 controls the influence of the single annotation.

### Learning Detectors (S122)

Once a set of regions have been identified from a set of the images which are predicted to each correspond to an object or part in a same category, a detector model 53 can be learned for identifying the object or part in new images 55. For example, the highest scoring ones of the set of regions are used as positive examples for learning a detector model (a classifier) for predicting the category label of a region of a test image 55. The test image region may be obtained by selective search or other region extraction method.

For example, a highest scoring one (or more) of the extracted regions is identified for each region. The region(s) are predicted, based on their representations, to be more likely (than other regions) to include an object or object part in one of the object/part categories. A set of object and part detectors 53, e.g., classifiers, can be learned on representations of these positive regions as well as representations of negative regions. In another embodiment a single detector 53 may be learned for multiclass classification of the object and its parts.

The region representations may be generated as described above for the appearance-based representations or using a different method.

### Using Detectors (S124)

Given a new image 55 to be labeled, regions of the image are extracted, e.g., using the method described in S110. The regions are classified by the detectors 53. Regions which are classified as including a part or an entire object by one of the detectors are labeled with the object or part label. As will be appreciated, part regions may overlap object regions and not all images processed will include a label for one or more of the object and its parts.

The image may be processed with detectors for a first object and its parts and detectors for at least a second object and its parts.

### Computing Kernels Over Regions in S116

A family of kernels over regions will now be described, which includes the common Intersection over Union measure, and demonstrate that they are positive definite kernels.

Let [symbol] be the Hilbert space of square integrable functions on [symbol] ² and, with simplification of notation, let R, Q ∈ [symbol] be the indicator functions of the respective regions. Then, regions can be thought of as vectors in [symbol] and the following theorem, holds:
Theorem 1 Let R and Q be vectors in a Hilbert space [symbol] such that [symbol] R,R [symbol] + [symbol] Q, Q [symbol] − [symbol] R, Q [symbol] >0. Then the function:

$$IoU ( R , Q ) = \frac{〈 R , Q 〉}{〈 R , R 〉 + 〈 Q , Q 〉 - 〈 R , Q 〉} \qquad ( 6 )$$

is a positive definite kernel.

Proof of Theorem 1. The function [symbol] R, Q [symbol] is the linear kernel, which is positive definite. This kernel is multiplied by the factor −1/k̅ where k̅(R, Q)= [symbol] R, Q [symbol] − [symbol] R, R [symbol] − [symbol] Q, Q [symbol] ; if this factor is also a positive definite kernel, then the result holds as the product of positive definite kernels is positive definite. −1/k̅ is positive definite if, and only if, k̅ is strictly negative (point-wise) and conditionally definite positive (according to Lemma 3.2 of Matthias Hein, et al., “Hilbertian metrics and positive definite kernels on probability measures,” Proc. AISTATS, pp. 136-143, 2005). The first condition is part of the assumptions. To show the second condition that k̅ is conditionally definite positive pick n vectors R₁, . . . , Rₙ and real numbers c₁, . . . , cₙ summing to zero c₁+ . . . +cₙ=0; then:

Σᵢⱼ cᵢk̅(Rᵢ, Qᵢ)cⱼ=Σᵢⱼ cᵢ [symbol] Rᵢ, Qⱼ [symbol] cⱼ≧0

where the terms [symbol] Rᵢ, Rᵢ [symbol] cancel out and [symbol] Rᵢ, Qⱼ [symbol] is positive definite.

For the case above where [symbol] R, Q [symbol] =∫R(x,y)Q(x,y)dx dy=|R ∩ Q|, Eqn. (6) results in the standard Intersection over Union measure. This demonstrates that IoU is positive definite.

The method illustrated in FIGS. 6 and 7 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 18, (for example, an internal hard drive of RAM), or may be separate (for example, an external hard drive operatively connected with the computer 18), or may be separate and accessed via a digital data network such as a local area network (LAN) or the Internet (for example, as a redundant array of inexpensive/independent disks (RAID) or other network server storage that is indirectly accessed by the computer 18, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 6 and/or 7, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

### Applications of the Method

Object detection is a major component in many business applications involving the understanding of visual content. For many of these applications, the joint detection of the object itself and of its semantic part(s) could improve existing solutions, or enable new ones.

For example, in the transportation field, the location license plates can benefit from considering license plates as a semantic part of the car category. Joint object and part detection may therefore be used to improve license plate detection and ultimately recognition of license plate numbers. This object-level structure understanding also enables improvements to be made in fine-grained classification tasks, such as make or model recognition of vehicles in images captured by a toll-plaza or car park camera. Vehicle parts recognized may include exterior parts of the vehicle as well as visible interior ones. In the retail business, detecting and counting specific objects in store shelves facilitates applications such as planogram compliance or out-of-stock detection. This detection task could be enhanced by reasoning jointly about objects and their parts. An image search engine could be conveniently used to train models.

Without intending to limit the scope of the exemplary embodiment, the following examples illustrate the application of the method to the identification of objects and their parts.

### EXAMPLES

The method described above was evaluated on two public benchmark datasets:

1. The labeled face parts in the wild (LFPW) dataset contains about 1200 face images annotated with outlines for landmarks. See, Peter N Belhumeur, et al., “Localizing parts of faces using a consensus of exemplars,” PAMI, pp. 2930-2940, 2013. The outlines were converted to bounding boxes annotations and images with missing annotations were removed from the test set. A random set of 500 images was used for the training set and 170 images as a test set, to locate the following categories: face, eye, eyebrow, nose, and mouth.

2. The PascalParts dataset augments the PASCAL VOC 2010 dataset with segmentation masks for object parts. See, Chen 2014. The segmentation masks were converted into bounding boxes for evaluation. Different part variants within the same categories (e.g., left wheel and right wheel) are merged into a single wheel class). Objects marked as truncated or difficult are not considered for evaluation. From this dataset, buses and cars are considered, giving 18 object types: car, bus, and their respective door, front, headlight, mirror, rear, side, wheel, and window parts. This dataset is more challenging than the first, as objects display large intra-class appearance and pose variations. The training set was used as is and the evaluated on images from the validation set that contain at least one object instance.

Images were retrieved from the web using the BING search engine. For each individual object and its parts the transformations on all BING and dataset images were decompose jointly, i.e., three geometric embeddings are learnt, one for faces, one for cars, and one for buses. MIL detectors are trained as follows. First, between 5 and 10 relocalization rounds were performed to train models for the appearance only (the exact number of rounds is validated on the validation set). Afterwards, a single relocalization round is performed to build appearance-geometry descriptors. Background clutter images were used as negative bags for all the objects. These were obtained from Li Fei-Fei, et al., “Learning generative visual models from few training examples: An incremental Bayesian approach tested on 101 object categories,” CVIU, 2007. Initial negative samples are fixed to the full negative images. In cases where hard negative mining does not hurt results on the validation set, the single highest scoring detection from each negative image was appended to the set of training samples during every relocalization round. In order to approximate the geometric kernel, 100 representatives were obtained separately for each category. The ρ parameter of the relaxed IoU measure is set to 0.1, 0.001 for bus and car parts respectively and 0.1 for LFPW. The representatives are re-estimated after every MIL relocalization round, using spectral clustering of the positive locations in the geometric kernel space. The geometric embedding of the negative samples is set to the mean over all the embedding vectors φ^{g} of the positive samples. At test time, non-maximum suppression is applied with an overlap threshold of 0.1. The MIL detectors are trained solely on Web images. All parameters are optimized on the training set of each dataset, and results are reported on their respective test set.

Evaluation metrics: The Average Precision (AP) per class and its average (mAP) over classes are computed. These are standard performance metrics for detection. The AP values are computed only from images where a positive object class is present. Also, the CorLoc (correct localization) measure is computed, as it is often used in the co-localization literature, although it does not penalize multiple detections (see, Thomas Deselaers, “Localizing objects while learning their appearance,” ECCV, pp. 452-466, 2010; Joulin 2014). As most parts in both datasets are relatively small, the IoU evaluation threshold is set to 0.4.

Variants of the method: To evaluate the performance of the method, the basic MIL baseline (B) as described above, was gradually adapted and the impact on the results was monitored. The exemplary method is evaluated in two modes: with and without using a single annotated example (A). The pipeline that uses context descriptors as described in the Geometry-aware multiple instance learning section, is abbreviated (B+C). The context descriptor for a region R is formed by concatenating the L²-normalized fc6 features from both R and a region surrounding R double its size. The pipelines that make use of the geometrical embeddings (section 3.2) are denoted with (G).

The exemplary method is compared with other methods:

1. The co-localization algorithm of Cho 2015. To detect an object part with the Cho method, their algorithm is run on all images that contain the given part (e.g., for co-localizing eye, face and eye images are considered).

2. A detector based on the single annotation (A).

3. A detector trained using full supervision for all objects and parts (F), which constitutes an upper-bound to the performance of the present algorithm. As a fully-supervised detector, the R-CNN method of Girshick 2014 is used on top of the same L²-normalized fc6 features used in MIL.

### Results

TABLE 1 shows the mAP and average CorLoc for the present method, the co-localization method of Cho 2015, and the fully-supervised upper-bound method. Tables 2 and 3 show the per-part detection results for classes related to faces and buses, respectively.

TABLE 1
Average CorLoc and mAP for the MIL baseline (B), the adapted
versions that use context (C), geometrical embedding (G) and/or
a single annotation (A), and the fully supervised R-CNN (F)
Each cell contains mAP or average CorLoc
over all the parts of a given class.

| | | mAP | | | average CorLoc [%] | | |
|---|---|---|---|---|---|---|---|
| Superv. | Method | face | bus | car | face | bus | car |
| Web | Cho 2015 | 12.1 | — | — | 15.0 | — | — |
| | B | 20.9 | 16.8 | 13.8 | 23.1 | 23.9 | 28.6 |
| | B + G | 20.9 | 16.9 | 13.2 | 23.8 | 23.3 | 26.8 |
| | B + C | 26.0 | 15.9 | 13.6 | 34.0 | 26.2 | 30.7 |
| | B + C + G | 36.8 | 17.4 | 14.1 | 44.7 | 25.9 | 31.9 |
| Web + 1 | A | 24.6 | 14.7 | 12.0 | 33.2 | 30.3 | 32.3 |
| annotation | B + A | 32.5 | 20.1 | 17.3 | 40.8 | 35.7 | 33.2 |
| | B + A + G | 33.9 | 20.5 | 18.3 | 42.9 | 37.3 | 36.1 |
| | B + A + C | 38.4 | 21.3 | 17.5 | 48.1 | 38.9 | 36.9 |
| | B + A + C + G | 43.2 | 22.1 | 17.0 | 54.2 | 38.1 | 36.8 |
| Full | F | 60.4 | 41.3 | 29.2 | 65.4 | 58.7 | 47.2 |

TABLE 2
AP for the MIL baseline (B) and adapted variants that use context (C), geometrical
embedding (G), and/or a single annotation (A), compared to the fully supervised
R-CNN (F), for the bus class and its part classes, on the PASCAL-Part dataset

| Superv. | Method | bus | door | front | headlight | mirror | rear | side | wheel | window | mAP |
|---|---|---|---|---|---|---|---|---|---|---|---|
| Web | B | 74.1 | 0.0 | 17.1 | 0.0 | 0.0 | 0.6 | 56.9 | 0.2 | 2.2 | 16.8 |
| | B + G | 79.1 | 0.0 | 10.0 | 0.0 | 0.0 | 0.3 | 59.6 | 0.5 | 2.6 | 16.9 |
| | B + C | 68.0 | 0.4 | 26.4 | 0.2 | 0.1 | 1.6 | 42.1 | 0.7 | 3.9 | 15.9 |
| | B + C + G | 76.2 | 0.1 | 18.2 | 0.1 | 0.1 | 0.4 | 55.9 | 0.2 | 5.1 | 17.4 |
| Web + 1 | A | 46.8 | 1.6 | 10.7 | 1 | 0 | 11 | 38.7 | 19.4 | 3.3 | 14.7 |
| annot. | B + A | 77.2 | 6.7 | 21.1 | 0.2 | 0.1 | 0.8 | 50.3 | 11.0 | 13.9 | 20.1 |
| | B + A + G | 70.7 | 6.7 | 12.2 | 0.5 | 0.1 | 0.6 | 55.0 | 20.0 | 18.4 | 20.5 |
| | B + A + C | 69.3 | 9.2 | 10.5 | 0.0 | 0.1 | 0.5 | 52.9 | 25.9 | 23.0 | 21.3 |
| | B + A + G + C | 66.1 | 13.7 | 18.8 | 0.3 | 0.1 | 0.7 | 52.8 | 25.4 | 21.1 | 22.1 |
| Full | F | 88.2 | 29.1 | 81.1 | 6.4 | 2.2 | 35.9 | 76.0 | 25.0 | 27.5 | 41.3 |

TABLE 3
AP for the MIL baseline (B) and adapted variants with context (C),
geometric embedding (G), and/or a single annotation (A), compared
to the fully supervised RCNN (F), for faces and its parts, on LFPW

| Superv. | Method | eye | eyebrow | face | mouth | nose | mAP |
|---|---|---|---|---|---|---|---|
| Web | B | 1.4 | 0.3 | 98.0 | 4.5 | 0.4 | 20.9 |
| | B + G | 4.4 | 0.3 | 98.2 | 0.9 | 0.6 | 20.9 |
| | B + C | 15.6 | 0.1 | 95.1 | 17.7 | 1.2 | 25.9 |
| | B + C + G | 54.5 | 0.1 | 95.6 | 13.2 | 20.6 | 36.8 |
| Web + 1 | A | 5.4 | 3.1 | 95.0 | 12.3 | 7.1 | 24.6 |
| Annot. | B + A | 36.4 | 1.7 | 97.3 | 20.7 | 6.4 | 32.5 |
| | B + A + G | 12.3 | 6.0 | 98.4 | 28.9 | 23.7 | 33.9 |
| | B + A + C | 43.0 | 5.8 | 92.9 | 31.4 | 18.9 | 38.4 |
| | B + A + G + C | 33.1 | 15.0 | 96.6 | 41.7 | 29.5 | 43.2 |
| Full | F | 51.7 | 22.2 | 99.4 | 75.2 | 53.3 | 60.4 |

The results on the LFPW dataset shown in Table 3 indicate that, on average, the present method improves detection significantly, as shown by the +21.6% CorLoc and +15.9 mAP differences between B and B+C+G. The improvements are particularly significant for noses (from 0.4 to 20.6) and for eyes (from 1.4 to 54.5). For some more challenging classes, that almost always appear concurrently with other parts on the retrieved images, the weakly supervised approach benefits from a single annotation. With a single annotation, the present method increases the AP for eyebrows from 1.7 to 15.0, and for mouths from 20.7 to 41.7.

For the more challenging PASCAL-Part dataset (TABLE 2), a gain is observed for the bus, side and the window classes (resp. +5 AP, +2.7 AP and +2.9 AP). Once a single annotation is provided, the mAP increases by 2.0 and 1.0 for buses and cars respectively. Among the highest part detection improvements, bus windows increase by 7.2 AP and bus doors increase by 7.0 AP. Low results are obtained for the classes headlights and mirrors that both stay below 1 mAP point. Yet, for these classes, even the fully supervised detector obtains only 6.4 and 2.2 AP respectively. For bus wheels, the present method performs as well as the fully supervised baseline.

Comparing the adapted MIL variants to the exemplary detector trained with a single annotation (A), it can be see that unless it is appropriately leveraged in the MIL algorithm, as described above, this is not enough to train a good detector. As an example, the exemplary method B+A+C+G outperforms A by 7.4 mAP on buses.

It is also noted that even the MIL baseline (B) method outperforms the approach of Cho 2015 on faces and their parts. In fact, Cho 2015 is only able to detect faces, and produces detections whose mAP and CorLoc are close to 0 for face parts. This suggests that the standard co-localization methods are not suited for this difficult scenario. Consequently, the method of Cho 2015 was not evaluated on the more challenging PascalParts dataset.

### Example Detections

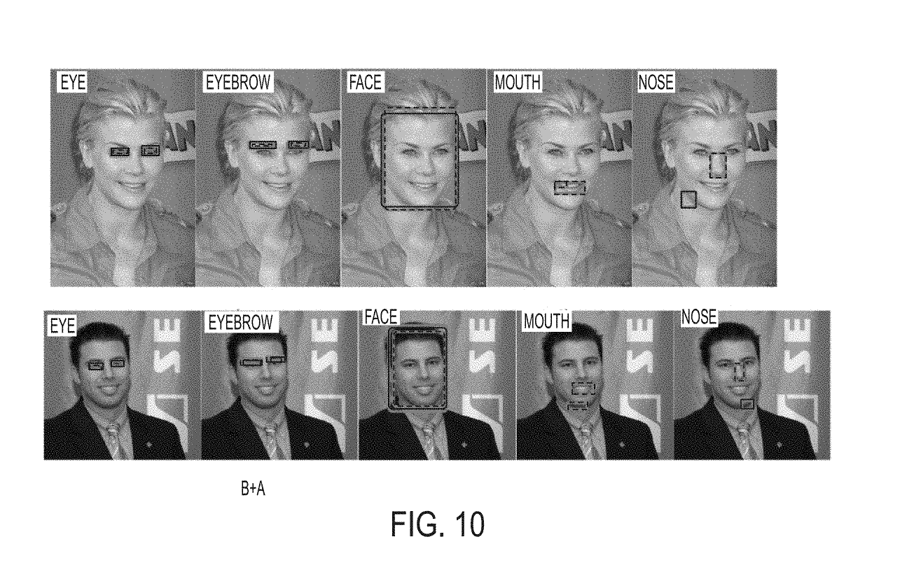

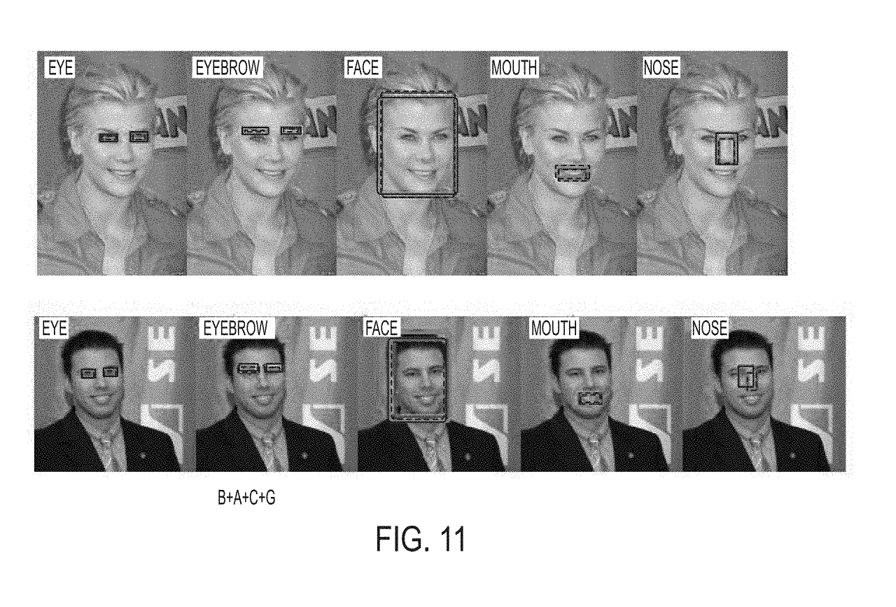

FIGS. 10 and 11 show example detections on the LFPW dataset for the B+A and B+A+C+G detectors. Dashed bounding boxes denote ground truth annotations, full bounding boxes show detector outputs. The examples show improvement in “mouth,” “nose” and “eyebrow” detections in the case of the B+A+C+G method.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for generating object and part detectors comprising:
accessing a collection of training images, the collection of training images including images annotated with an object label and images annotated with a respective part label for each of a plurality of parts of the object;
generating joint appearance-geometric embeddings for regions of a set of the training images;
learning at least one detector for the object and its parts using annotations of the training images and respective joint appearance-geometric embeddings; and
outputting information based on the object and part detectors, wherein at least one of the generating of the joint appearance-geometric embeddings, and the learning of the object and part detectors is performed with a processor.

2. The method of claim 1, wherein the at least one detector is trained by multi-instance learning.

3. The method of claim 1, wherein the generating of the joint appearance-geometric embeddings comprises, for each of a plurality of regions:
generating an appearance-based representation of the region;
generating a geometric embedding of the region; and
aggregating the appearance-based representation and geometric embedding to generate a joint appearance-geometric embedding for the region.

4. The method of claim 3, wherein the appearance-based representation of the region is a multidimensional representation of pixels in the region.

5. The method of claim 3, wherein the generating of the geometric embedding of the region comprises:
identifying similar regions in a set of training images based on the appearance-based representations of the regions;
for pairs of training images in the set of training images, learning a pairwise transformation to align a pair of training images in the set, based on respective locations of at least some of the similar regions in the pair of images; and
generating an image transformation for mapping each training image in the set to a common frame based on the pairwise transformations for the training image; and
computing the geometric embedding for regions of the training images in the set based on the respective image transformation.

6. The method of claim 5, further comprising identifying a set of matching pairs of similar regions based on a measure of overlap of the similar regions, the pairwise transformation being learned based on the locations of at least some of the matching pairs of regions.

7. The method of claim 5, wherein the generating of the image transformation comprises decomposing the pairwise transformations for that image to generate a transformation to the common frame.

8. The method of claim 5, wherein the computing of the geometric embedding for each region comprises projecting the inverse transform of that region in a common embedding space into a set of reference regions.

9. The method of claim 3, wherein the aggregating the appearance-based representation and geometric embedding comprises computing a Kronecker product of the appearance-based representation and the geometric embedding.

10. The method of claim 1, further comprising identifying a set of similar images based on representations of the images and respective image labels, the generating of joint appearance-geometric embeddings being performed for regions of the training images in the set.

11. The method of claim 10, wherein the identifying a set of similar images comprises computing a minimum spanning tree over a graph in which nodes of the graph represent images having a common label and edges connecting the nodes represent distances between the images based on image representations of the images.

12. The method of claim 1, wherein the learning at least one detector for the object and its parts comprises learning parameters of a scoring function for scoring regions of the training images based on the joint appearance-geometric embeddings.

13. The method of claim 12, wherein the learning parameters comprises optimizing a function over a number of images:
$${min}_{w ∈ {ℝ}^{d}} \frac{λ}{2} {‖ w ‖}^{2} + \frac{1}{n} {\sum }_{i = 1}^{n} max \{ 0 , 1 - {y}_{i} {max}_{R ∈ ℛ ( {x}_{i} )} Γ ( {x}_{i} , R \vert w ) \}$$
where w represents a vector of the parameters;
$$\frac{λ}{2}$$
is a constant;
n is the number of images;
yᵢ is a label which is positive if the region is in an image i drawn from a positive set of images that are labeled with a common label and is negative otherwise, and
Γ(xᵢ, R|w) is a region score which is computed with the parameters w and the joint embedding of a region R drawn from a set [symbol] of regions in the respective image xᵢ.

14. The method of claim 13, wherein the region score Γ(xᵢ, R|w) is computed as a function of: [symbol]
φ^{a}(x|R) [symbol] φ^{g}(Tᵢ⁻¹R), w [symbol] ,
where [symbol] represents an aggregating function,
φ^{a}(x|R) is the appearance-based representation of a region R from an image;
φ^{g}(Tᵢ⁻¹R) is the geometric representation of the region R;
w is a vector of parameters; and [symbol]
•, • [symbol] denotes a scalar product.

15. The method of claim 13, wherein the region scores Γ(xᵢ, R|w) are weighed by the similarity between the joint embedding and an appearance descriptor of an annotated region of a region-annotated training image, in which the annotated region is annotated with the same label.

16. The method of claim 1, wherein the learning at least one detector for the object and its parts comprises:
for each of a set of training images having a common label, identifying a region in the training image, the identified region being one which has a highest score computed with a scoring function which is a function of the joint appearance-geometric embedding of a region and a vector or parameters; and

17. The method of claim 1, wherein the output information comprises the at least one detector.

18. The method of claim 1, wherein the method further comprises labeling at least one region of a new image with the trained at least one detector and wherein the output information comprises a label for the at least one region.

19. The method of claim 18, wherein the output information comprises object and part labels for regions of the image.

20. A computer program product comprising non-transitory memory storing instructions, which when executed by a computer, perform the method of claim 1.

21. A system comprising memory which stores instructions for performing the method of claim 1 and a processor in communication with the memory for executing the instructions.

22. A system comprising object and part detectors generated by the method of claim 1.

23. A system for labeling regions of an image corresponding to an object and its parts, comprising:
memory which stores a detector for the object and detectors for each of a plurality of parts of the object, each of the detectors having been learnt on regions of training images scoring higher than other regions on a scoring function which is a function of a joint appearance-geometric embedding of the respective region and a vector or parameters, the joint appearance-geometric embedding being a function of an appearance-based representation of the region and a geometric embedding of the region, the vector of parameters having been learned with multi-instance learning; and
a processor which applies the detectors to a new image and outputs object and part labels for regions of the image.

24. A method for generating object and part detectors comprising:
accessing a collection of training images, the training images including images annotated with an object label and images annotated with a respective part label for each of a plurality of parts of the object;
identifying a set of similar images in the collection, the similar images being identified based on image representations of the images, at least some of the images in the set having a label in common;
extracting a set of regions from each image in the set;
generating appearance-based representations of the extracted regions;
for each of at least a subset of the set of the training images, generating an image transformation which maps the respective training image to a common frame, based on the appearance-based representations of at least some of the regions of training image and matching appearance-based representations of at least one of the other images in the set;
generating geometric embeddings of at least a subset of the extracted regions from each image with the respective learned transformation;
generating joint appearance-geometric embeddings for regions in the subset of the extracted regions, based on the respective appearance-based representation and geometric embedding;
learning a parameter vector with multi-instance learning for weighting joint appearance-geometric embeddings in a scoring function;
identifying regions of the training images in the subset having scores generated by the scoring function that are higher than for regions of images in the training set which do not have the common label;
learning detectors for the object and its parts using representations of the identified regions; and
wherein at least one of the steps of the method is performed with a processor.
